(19) United States
(12) Patent Application Publication
(10) Pub. No.: US 2006/0117528 A1
(43) Pub. Date: Jun. 8, 2006

(54) Hinge assembly with a rolling means

(75) Inventors: Chao Duan, Shenzhen (CN); Ying-Liang Tu, Shenzhen (CN); Mao-Fa Jiang, Shenzhen (CN); Qin Ou-Yang, Shenzhen (CN); Shun Guo, Shenzhen (CN); Chia-Hua Chen, Tu-cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO., LTD., Shindian City (TW)

(21) Appl. No.: 11/261,103

(22) Filed: Oct. 28, 2005

(30) Foreign Application Priority Data
Dec. 2, 2004 (CN) 200420102400.5

(51) Int. Cl. E05F 1/08

(52) U.S. Cl. 16/303

(57) ABSTRACT

A hinge assembly includes a shaft (10), a follower (12), a cam (20), at least one rolling member (40), and a spring (50). The follower is connected with the shaft. One of the shaft and the follower has a securing portion (11). The cam is essentially in the shape of a cylinder. The cam has a cam surface (24) and has a cam hole (22) extending therethrough. The cam hole receives the shaft there through. Each rolling member is disposed between the follower and the cam. The first end of the urging means abuts the shaft, while an opposite second end of the urging means biases the cam. The cam surface of the cam is rotatably and movably engaged with each rolling member under the force of the spring.

### 1. FIELD OF THE INVENTION

The present invention relates to hinge assemblies and, particularly, to a hinge assembly for foldable electronic devices, such as mobile telephones, electronic notebooks, and so on.

### 2. DISCUSSION OF THE RELATED ART

With the development of the technologies of wireless communication and information processing, portable electronic devices, such as mobile telephones and electronic notebooks, are now in widespread use. These electronic devices enable consumers to enjoy the convenience of high technology services, anytime and anywhere. Foldable electronic devices are particularly welcome by consumers for their convenience.

Generally, foldable electronic devices have most of the electronics in one housing, called the body. The other housing, called the cover, normally contains fewer electronic components than the body. Other foldable electronic devices have all the electronics in the body, with the cover containing no electronics. Various types of hinge assemblies are used to join a body and a cover of a foldable electronic device, so that the cover can unfold up from and fold down upon the body. Manufacturers are constantly seeking to reduce the volume, size and/or weight of portable foldable electronic devices. Thus, it is desirable that the hinge assembly coupling the main housing with the cover is modularized and miniaturized. A modularized hinge assembly has moving parts such as a cam member, a cam follower, a shaft, and a spring, held together in a unified structure. One of the cam member and the cam follower directly contacts the spring. The structure is easily and quickly attached to the main housing and the cover during mass production. The cam member and the cam follower always contact each other under the force of the spring.

Although suitable for some foldable electronic devices, sliding friction is produced between the cam member and the cam follower because of the relative rotation therebetween. This friction wastes energy (i.e., making opening and/or closing of the device more difficult) and causes abrasion of the cam member and the cam follower. The abrasion can further add to the friction therebetween and may eventually lead to premature malfunction or failure of the hinge assembly

What is needed, therefore, is a hinge assembly which has a relatively simple and small modularized configuration, which can be produced at low cost, and which has a relatively low amount of friction associated therewith.

### SUMMARY OF THE INVENTION

In a preferred embodiment, a hinge assembly is provided for joining a flip cover to a main body of a foldable electronic device. The hinge assembly includes a shaft, a follower, a cam, at least one rolling means, and an urging means. The follower is connected with the shaft. One of the shaft and the follower has a securing portion. The cam is essentially in the shape of a cylinder. The cam includes a cam surface and has a cam hole extending therethrough. The cam hole receives the shaft therethrough. The at least one rolling means is disposed between the follower and the cam. One end of the urging means abuts the shaft, and an opposite end of the urging means biases against the cam. The cam surface of the cam is rotatably and movably engaged with the rolling means under force of the urging means.

A main advantage of the above-described hinge assembly is that the cam and the follower do not directly contact each other, which reduces the friction associated with relative rotation between the cam and the follower. Accordingly, when the hinge assembly is assembled in a mobile phone, the energy required in opening the flip cover of the mobile phone is reduced. Furthermore, the working lifetime, on average, of the hinge assembly is prolonged.

Other advantages and novel features will become more apparent from the following detailed description when taken in conjunction with the accompanying drawings.

### BRIEF DESCRIPTION OF THE DRAWINGS

Many aspects of the hinge assembly can be better understood with reference to the following drawings. The components in the drawings are not necessarily to scale, the emphasis instead being placed upon clearly illustrating the principles of the present hinge assembly. Moreover, in the drawings, like reference numerals designate corresponding parts throughout the several views.

FIG. 1 is an isometric view of a flip-type mobile phone according to a preferred embodiment, the hinge assembly being shown with dashed lines;

FIG. 2 is an enlarged, exploded, isometric view of the hinge assembly of FIG. 1;

FIG. 3 is an assembled view of the hinge assembly of FIG. 2; and

FIG. 4 is an assembled view of the hinge assembly of FIG. 2, showing the hinge assembly in a first position corresponding to a closed position of a foldable electronic device.

### DETAILED DESCRIPTION OF PERFERRED EMBODIMENTS

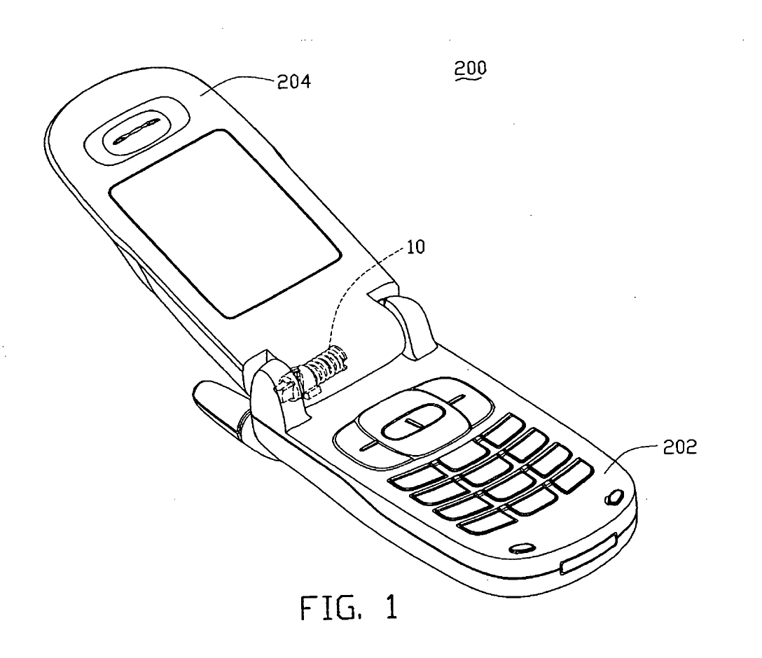

Referring now to the drawings, FIG. 1 shows a flip type mobile phone 200, which includes a hinge assembly 100 (according to a preferred embodiment), a main body 202, and a flip cover 204. The main body 202 and the flip cover 204 are pivotally connected to each other via the hinge assembly 100.

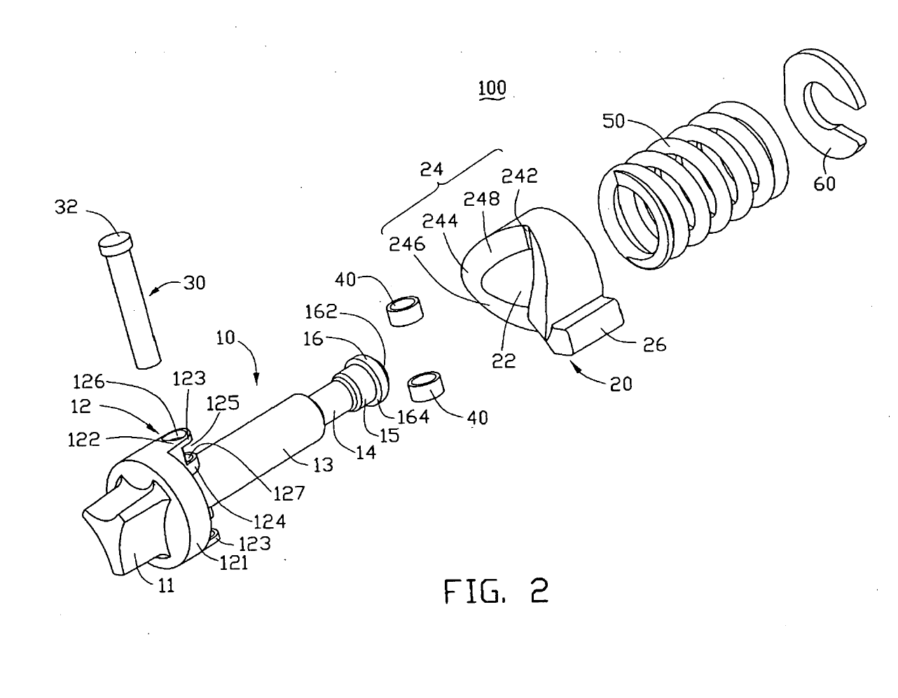

FIG. 2 shows various parts of the hinge assembly 100. The hinge assembly 100 may be used to interconnect components like a main body and a flip cover of any of various different kinds of foldable electronic devices, such as the flip type mobile phone 200. Furthermore, the hinge assembly 100 may prove useful in other applications (e.g., cabinet doors) beyond foldable electronic devices, and such uses are considered to be within the scope of the present hinge device. Referring now to FIG. 2, the hinge assembly 100 includes a shaft 10, a cam 20, a pin 30 functioning as a positioning member, two rolling barrels 40, each functioning as a rolling means, a spring 50 functioning as an urging means, and a C-clip 60. The shaft 10 extends through the cam 20, the spring 50, and the C-clip 60, in that order, thereby integrating the hinge assembly 100 into a complete unit.

The shaft 10 includes, in sequence, a securing portion 11 formed at one end thereof, a follower 12 adjacent the securing portion 11, a large diameter portion 13, a neck portion 14, a small diameter portion 15, and a latching portion 16 formed at another end thereof, adjacent the small diameter portion 15. The securing portion 11 is configured for engaging/connecting with the main body 202 of the mobile phone 200. The follower 12 includes an enlarged cylindrical portion 121 and two symmetrically opposite finger portions 122. Each finger portion 122 extends in an axial direction relative to the enlarged cylindrical portion 121 and adjoins one end of the large diameter portion 13. Each finger portion 122 further has a first sidewall 123 and an opposite second sidewall 124 at the distal end thereof. The first sidewall 123 and the second sidewall 124 cooperatively define a receiving groove 125 therebetween, the receiving groove 125 being configured for receiving one of the two rolling barrels 40. Each first sidewall 123 has a pinhole 126 therein configured for communicating with the receiving groove 125. The large diameter portion 13 of the shaft 10 defines a through hole 127. The through hole 127 corresponds to the pinhole 126 and has a same diameter as the pinhole 126. The through hole 127 extends through the second sidewall 124 of the finger portion 122. The diameter of the pinhole 126 and the through hole 127 is same as the diameter of the pin 30. A diameter of the latching portion 16 is larger than that of the small diameter portion 15. The latching portion 16 has a slant surface 162 configured for guiding insertion thereof into one of the main body 202 and the flip cover 204, and defines an engaging step 164 where the latching portion 16 adjoins the small diameter portion 15.

The cam 20 is a generally cylindrical body and has a central cam hole 22 therethrough. The cam 20 has a cam surface 24 formed at one end thereof. The cam surface 24 includes two valleys 242, two peaks 244, two moderate inclined planes 246, and two steep inclined planes 248. Preferably, the valleys 242 are located 180 degrees opposite from each other, and the peaks 244 are located 180 degrees opposite from each other. Such a layout of the valleys 242 and peaks 244 facilitates the opening of the device to a full-open, 180° alignment. Other alignments of the valleys 242 and peaks 244 may be chosen if a full-open, angled alignment is instead desired. The cam 20 has a protrusion 26 formed on outer peripheral wall thereof and is oriented parallel to a central axis of the cam 20. The protrusion 26 is configured for engaging with the flip cover 204 of the mobile phone 200.

The pin 30 is cylindrical and has a discoid (i.e., disc-shaped) head 32 at one end thereof. The pin 30 has a diameter corresponding to a common diameter of the pinholes 126 and the through hole 127. In the preferred embodiment, the pin 30 has a diameter slightly larger than the diameter of the pinholes 126 and the through hole 127, so that the pin 30 can be inserted into and interferingly fixed with the shaft 10.

Each rolling barrel 40, one located on either side of shaft 10 in a given receiving groove 125, is a generally cylindrical body with two open ends. The inner diameter of each rolling barrel 40 is same as the diameter of the pin 30. In the preferred embodiment, each rolling barrel 40 has an inner diameter slightly larger than the diameter of the pin 30, so that the pin 30 can freely pass through the rolling barrel 40, and each rolling barrel 40 can rotate relative to the pin 30. The outer diameter of each rolling barrel 40 is larger than that of the corresponding receiving groove 125 of the shaft 10, so that a portion of the rolling barrels 40 protrudes out of the finger portion 122 of the follower 12 when the rolling barrels 40 are received in the respective receiving grooves 125.

The spring 50 is advantageously metallic and helical, with an inner diameter larger than a diameter of the large diameter portion 13 of the shaft 10. Thus, the spring 50 can be located around the shaft 10. A first end of the spring 10 resists one surface of the cam opposite to the cam surface 24, and an opposite second end of the spring 50 biases against the C-clip 60. It is, however, to be understood that any spring 50, regardless of configuration or composition, which may be suitably employed to bias both against the one surface of the cam opposite to the cam surface 24 and against the C-clip 60 is considered to be within the scope of the present hinge system.

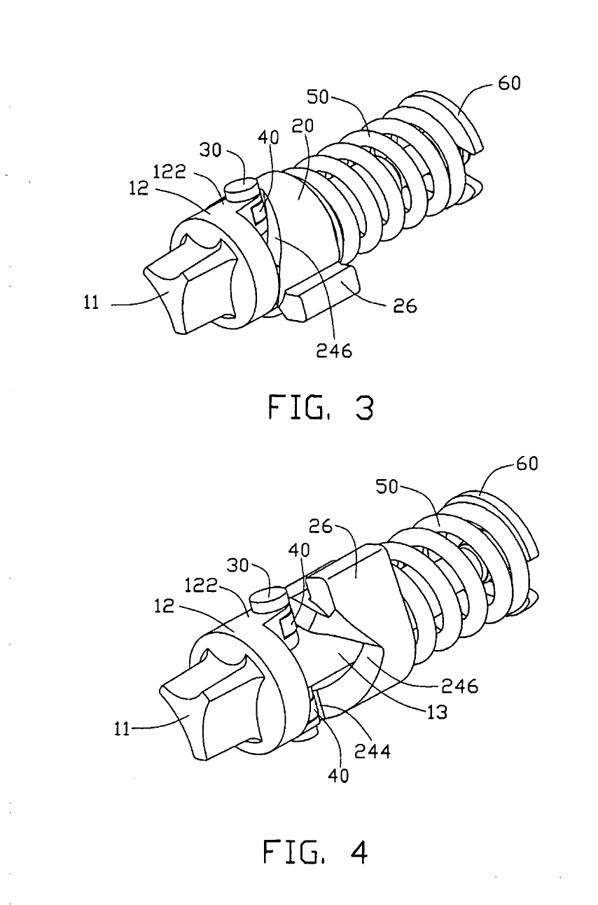

In assembly of the hinge assembly 100, firstly, each rolling barrel 40 is respectively received in a corresponding receiving groove 125, with the two open ends of each rolling barrel 40 respectively aligning with the pinhole 126 of the first sidewall 123 and the through hole 127 of the shaft 10. A portion of each rolling barrel 40 protrudes beyond the respective finger portion 122 of the follower 12. Secondly, the pin 30 is inserted into the pinhole 126, the rolling barrel 40 and the through hole 127, in that order, such that the rolling barrels 40 are movably connected with the follower 12 of the shaft 10. Thirdly, the shaft 10 is passed through the cam hole 22 of the cam 20, the spring 50, and the C-clip 60, in that order. The C-clip 60 is snap-fit around the small diameter portion 15 of the shaft 10, such that the spring 50 is at least slightly compressed, even at when at the maximum extension allowed in the assembled state of the hinge assembly 100. The first end of the spring 50 resists a surface of the cam 20 opposite to the cam surface 24. The second end of the spring 50 biases against the C-clip 60. The engaging step 164 of the latching portion 16 opposes the C-clip 60 and prevents the C-clip 60 from falling off from the end of the shaft 10. The cam surface 24 of the cam 20 always contacts the rolling barrels 40 no matter what rotational position the cam 20 is in, because of the urging force of the spring 50. The hinge assembly 100 is thus completely assembled, as shown in FIG. 3.

Referring to FIG. 1, in use, the protrusion 26 is engaged in a cavity (not shown) of the flip cover 204 of the mobile phone 200, and the securing portion 11 of the shaft 20 is engaged in the main body 202 of the mobile phone 200. When the flip cover 204 of the mobile phone 200 is in a fully closed position or a fully open position, the rolling barrels 40 are engageably located in the valleys 242 of the cam 20.

Referring also to FIGS. 3 and 4, when the flip cover 204 of the mobile phone 200 is rotated between an open position and a closed position (or vice versa), the cam 20 rotates along with the flip cover 204, while the shaft 10 remains fixed in the main body 202 of the mobile phone 200. As a result, a relative rotation is produced between the cam 20 and the follower 12 of the shaft 10. Because the rolling barrels 40 are connected with the follower 12 of the shaft 10, the rolling barrels 40 rotate relative to the cam 20. The rolling barrels 40 ride along the moderate inclined planes 246 of the cam surface 24 from the valleys 242 to the peaks 244 (see FIG. 4), with the cam 20 moving toward and compressing the spring 50. Because the cam 20 and the follower 12 resist each other via the rolling barrels 40, only a rolling friction is produced between the cam 20 and the follower 12. Once the rolling barrels 40 pass over the peaks 244, the spring 50 decompresses and drives the cam 20 back toward the follower 12, with the rolling barrels 40 riding along the steep inclined planes 248 from the peaks 244 to the valleys 242. The flip cover 204 is thus rotated automatically to the fully closed position (or fully open position) under the decompression force of the spring 50. Accordingly, the flip cover 204 is moved 180 degrees (or another predetermined maximum angular amount, determined by the hinge configuration) relative to the main body 202, with the rolling barrels 40 once again mating in the valleys 242. In this way, the flip cover 202 is closed (or opened). Preferably, the structures of the flip cover 204 and the main body 202 are adapted to control the degree of rotation of the hinge assembly, such that the finger portions 222 can be held in one or more particular locations between the valleys 242 and the peaks 244.

The rolling barrels 40 protrude out of the finger portion 122 of the follower 12 of the shaft 10 and engage with the cam surface 24 of the cam 20. A main advantage of the hinge assembly 100 is that the cam 20 and the finger portion 122 of the shaft 10 are not directly contacting each other, thereby reducing the friction associated with relative rotation between the cam 20 and the follower 12. Accordingly, when the hinge assembly 100 is assembled in the mobile phone 200 or another device, the energy required in opening the flip cover 204 of the mobile phone 200 is reduced. Furthermore, the wear of the cam 20 and the follower 12 is reduced, and the working lifetime, on average, of the hinge assembly 100 should be prolonged.

In further alternative embodiments, the follower 12 can be a separate element that is not integrally formed with the shaft 10. In such case, the follower 12 defines a shaft hole and has a finger portions. The rolling barrels 40 can be replaced by another kind of rolling means, such as roller bearings. In this situation, the pin 30, the pinholes 126, and the through hole 127 could be omitted, it would be, instead, only required that the receiving groove 125 be a hemispherical groove. Each roller bearing would be received in the hemispherical groove 125. The spring 50 can be made of nonmetallic material, such as plastic. Further, the spring 50 can instead be another kind of elastic element or urging means known in the art, such as a resilient cylinder. The C-clip 60 can be omitted, in which case the spring 50 directly resists the latching portion 16. Additionally, there can be more than one protrusion 26.

In another alternative embodiment, the pin 30 is omitted, the rolling barrels 40 are replaced by at least one rolling post. Each finger portion 122 of the follower 12 would define a latching groove configured for latching the rolling post. In assembly, the rolling post would be received in the latching groove and could rotate relative to the finger portion 122 of the follower 12. Each rolling post would engage with the cam surface 24 of the cam 20.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A hinge assembly, comprising:
a shaft;
a follower connecting with the shaft, at least one of the shaft and the follower comprising a securing portion;
a cam essentially in the shape of a cylinder, the cam comprising a cam surface and having a cam hole extending therethrough, the cam hole receiving the shaft therethrough;
at least one rolling means disposed between the follower and the cam; and
an urging means having a first end and an opposite second end, the first end of the urging means abutting the shaft, the opposite second end of the urging means biasing the cam, the cam surface of the cam being rotatably and movably engaged with the rolling means under force of the urging means.

2. The hinge assembly as claimed in claim 1, wherein the follower comprises a cylindrical portion and two symmetrically opposite finger portions, each finger portion extending in an axial direction relative to the cylindrical portion.

3. The hinge assembly as claimed in claim 1, wherein the at least one rolling means are two rolling barrels.

4. The hinge assembly as claimed in claim 1, wherein the follower comprises at least one finger portion, each finger portion defining a receiving groove, each receiving groove being configured for receiving a corresponding rolling means.

5. The hinge assembly as claimed in claim 4, wherein each finger portion has a first sidewall and an opposite second sidewall at distal end thereof, the receiving groove being defined between the first sidewall and the second sidewall, cooperatively.

6. The hinge assembly as claimed in claim 5, wherein the first sidewall defines a pinhole, the hinge assembly further comprises a positioning member, the positioning member passing through the pinhole and each rolling means.

7. The hinge assembly as claimed in claim 6, wherein the positioning member is a pin, each rolling means being a rolling barrel.

8. The hinge assembly as claimed in claim 1, wherein the follower and the shaft are integrally formed, the follower being adjacent the securing portion, the follower comprising two finger portions, the cam surface of the cam being rotatably and movably engaged relative to the finger portions.

9. The hinge assembly as claimed in claim 1, further comprising a C-clip secured to a distal end of the shaft, the first end of the urging means abutting the C-clip.

10. The hinge assembly as claimed in claim 1, wherein the urging means is a helical spring located around the shaft.

11. The hinge assembly as claimed in claim 1, wherein the cam surface has a pair of opposite valleys and a pair of opposite peaks.

12. The hinge assembly as claimed in claim 1, wherein the shaft further comprises a latching portion, the latching portion being formed at an opposite end of the shaft, one end of the urging means abutting the latching portion.
